(19) United States
(12) Patent Application Publication
(10) Pub. No.: US 2022/0245898 A1
(43) Pub. Date: Aug. 4, 2022

(54) AUGMENTED REALITY BASED ON DIAGRAMS AND VIDEOS

(71) Applicants: Kelsey L. Bruso, Eagan, MN (US); James M. Plasek, Eagan, MN (US)

(72) Inventors: Kelsey L. Bruso, Eagan, MN (US); James M. Plasek, Eagan, MN (US)

(73) Assignee: Unisys Corporation, Blue Bell, PA (US)

(21) Appl. No.: 17/165,031

(22) Filed: Feb. 2, 2021

(51) Int. Cl. G06T 19/00; G06Q 10/06; G06K 9/00; G06F 16/783; G06F 16/732

(52) U.S. Cl. CPC G06T 19/006; G06Q 10/06311; G06F 16/7328; G06F 16/783; G06K 9/00718

(57) ABSTRACT

A computer implemented method of training a user to perform a task includes receiving task data from a user device; identifying a task associated with the task data; querying a knowledgebase for data associated with the task; generating an AR pattern for training the user to perform the task; and transmitting the AR pattern to the user device. An augmented reality training system includes a computer device connected to a user device having a video camera. The computer device receives the video data from the video camera and identifies a task from the digital video data. A knowledgebase is connected to the computer device. The knowledgebase contains resources related to the task. The system identifies a task to be performed, queries the knowledgebase for resources and creates an augmented reality pattern with an avatar from the resources for training a user.

### FIELD OF THE DISCLOSURE

The present application relates generally to augmented reality, and more particularly to the use of augmented reality to train or teach a person how to complete a task.

### BACKGROUND

Instruction manuals are commonly used to teach a user how to complete a task, such as assembling a product. One challenge with instruction manuals is that they are hard to understand for various reasons. For example, instructions may be poorly written so that they are unclear, overly complicated, or filled with unfamiliar jargon. Instruction manuals may not be in a language that the user fully understands. Another issue is that instruction manuals may not provide images of every step that a user needs to complete. In the past a solution might be to produce a video featuring a person completing the task with verbal instructions detailing each step to the user. One common problem with this (and with traditional instruction manuals) is that the instructions are presented from an unnatural viewpoint for the user, and the user is unable to see how their body is supposed to move to complete the task. Instruction manuals and videos are typically presented with a front view as opposed to a back view. In a front view, the user sees another person complete a task. In a back view, the user has the same view as when the user performs the task. Another issue for both instruction manuals and instruction videos is that the user receives no feedback on if they have correctly completed the step. Therefore, improvements are desirable.

### SUMMARY

In one aspect of the present disclosure, a computer implemented method of training a user to perform a task, includes receiving task data from a user device; identifying a task associated with the task data; querying a knowledgebase for data associated with the task; generating an AR pattern for training the user to perform the task; and transmitting the AR pattern to the user device.

In another aspect of the present disclosure, an augmented reality training system is taught. A computer device is connected to a user device having a video camera. The computer device receives the video data from the video camera and identifies a task from the digital video data. A knowledgebase is connected to the computer device. The knowledgebase contains resources related to the task. The system identifies a task to be performed, queries the knowledgebase for resources and creates an augmented reality pattern with an avatar from the resources for training a user.

In yet another aspect, a computer device for training a user to perform a task is disclosed. The computer device includes software for receiving digital video data from a user device; software for identifying a task associated with the digital video data; software for querying a knowledgebase for data associated with the task; software for generating an AR patient for training the user to perform the task; and software for transmitting the AR pattern to the user device.

### BRIEF DESCRIPTION OF THE FIGURES

For a more complete understanding of the disclosed system and methods, reference is now made to the following descriptions taken in conjunction with the accompanying drawings.

FIG. 1 is a schematic diagram of an augmented reality training, according to one embodiment.

FIG. 2 is a flow diagram of a method of training a person to complete a task using an augmented reality training system, according to one example embodiment of the present invention.

FIG. 3 is a block diagram illustrating a user device for an augmented reality training system, according to one embodiment.

FIG. 4 is a block diagram of a knowledgebase used within an augmented reality training system, according to one example embodiment.

FIG. 5 is a block diagram illustrating a computer network, according to one example embodiment of the present invention.

FIG. 6 is a block diagram illustrating a computer system, according to one example embodiment of the present invention.

### DETAILED DESCRIPTION

Instruction manuals and videos allow users to perform tasks that they have little to no prior knowledge about or experience with. Instruction manuals have several issues. Instruction manuals can be long and make a task appear daunting. Instruction manuals can be hard to understand. They may be poorly written or be in a language that the user is not comfortable with. Instruction manuals can include images, but these images are often presented from a front view rather than a back view. A front view can cause confusion as the user must orient themselves to the image and determine if the right side of the image corresponds to the user's right side or the user's left. The user is unable to see how their body is supposed to move to complete the task. Also, the instruction manual may not provide images of every step, requiring the user to guess. Instruction manuals also lack the ability to provide feedback to the user about whether the user has successfully completed steps to the task or if the user has made an error that needs correction. Instructional videos can overcome some of these issues by demonstrating tasks to the user. However, instructional videos do not overcome all the challenges. Instructional videos are typically presented from a front view and have no ability to provide feedback. Augmented Reality can be used to overcome these issues.

Augmented Reality (“AR”) is an interactive experience of a real-world environment where the objects that reside in the real world are enhanced by computer-generated perceptual information, sometimes across multiple sensory modalities, including visual, auditory, haptic, somatosensory and olfactory. AR allows users to have an interactive experience of a real-world environment where objects in the real world are enhanced by computer generated perceptual information. AR has three basic features: (1) a combination of real and virtual worlds, (2) real-time interaction, and (3) accurate 3D registration of real and virtual worlds. AR technology works by taking in the real-world environment and digitally manipulating it to include or exclude objects, sounds, and other things perceivable to the user. AR systems use various hardware components including a processor, a display or output devices, and input devices. Input devices may include sensors, cameras, microphones, accelerometers, GPS systems, and solid-state compasses. Modern mobile devices such as smartphones and tablet computers contain these elements.

The present disclosure teaches a system that uses AR to train a person how to complete a task. Task is broadly defined. Examples of a task include assembling, dissembling or repairing a product, playing a video game and completing an exercise routine. Tasks can be manually selected by the user or identified by the system via a smart search. For example, the user takes a picture of the product with an app. Based on the picture, the system can identify the product. Once the system has identified the object or task, it queries a knowledgebase for any and all resources related to the objector task, for example, user manuals, service manuals, how-to-videos, exploded diagrams, blueprints, other user comments, etc. Because the system is reading the instructions and diagrams and interpreting the information for the user, the system can help users who have trouble reading the instructions (because the font is too small, bad vision, lighting conditions, language difficulties, etc.) The system also helps to locate things that are not readily visible on the object being addressed, e.g., on the bottom.

The system uses the information stored in the knowledgebase to create AR patterns that instruct the user how to perform a task using an avatar of the user's body. In the above example of the product picture, the system would create AR patterns that instruct the user how to assemble, repair or dissemble the product. The AR pattern is displayed to the user by the system. The user follows the instructions provided by the avatar to complete the task. In some embodiments, the system could be configured to evaluate the user's performance and notify the user of any errors made. For example, if the AR pattern contains sound, the system will match the actual sound to the correct sound in the pattern and notify the user. If the AR pattern contained eye goggles for safely, the system would look for safety goggles on the user.

Once an AR pattern has been created, the system stores the AR pattern so that it can produce an AR pattern more efficiently when the same or similar task is identified in the future. The system uses artificial intelligence (“AI”) to improve and update AR patterns based on, among other things, user input and common errors experienced by users over time. AR patterns may also be retained by users for future use.

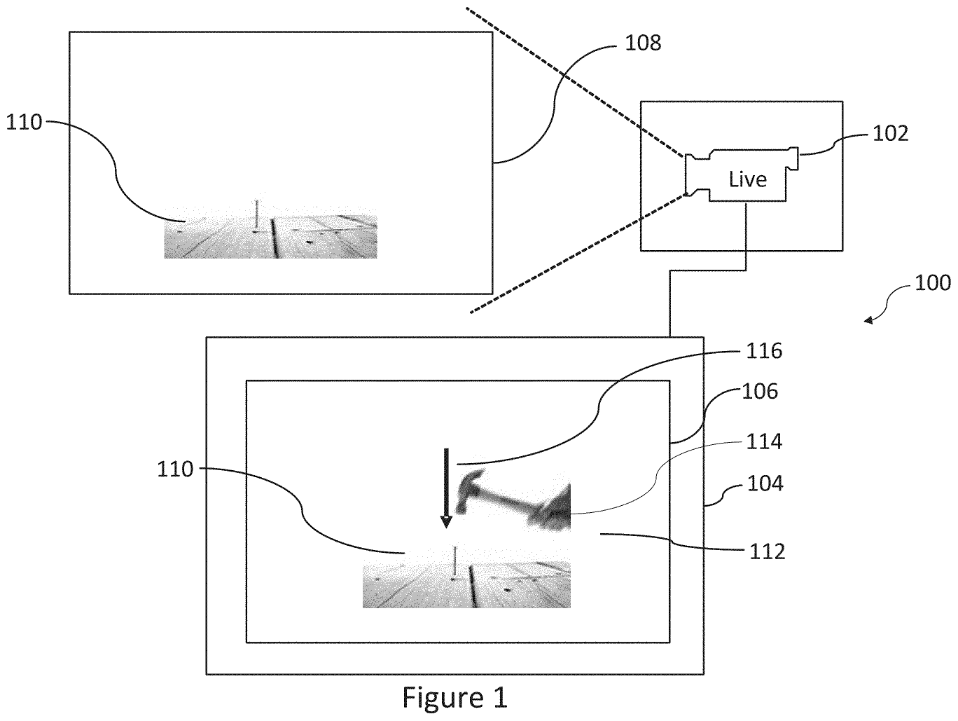

Referring to FIG. 1, an augmented reality training system 100 is shown. In this embodiment the user has a user device, such as a mobile phone that contains a video camera 102 and a display 106. The video camera 102 captures live video or a picture from a real-world field of view 108 and translates the video into digital video data. Within the real-world field of view 108, there is a task 110 (hammering a nail) that the user wishes to complete. The system identifies the task 110 and queries its knowledgebase to determine how to complete the task 110. From the results, the system creates or finds an existing AR pattern for completing the task 110. The AR pattern is displayed to the user using the device display 106. The augmented reality view 112 contains a view of the task 110 and an avatar 114 of the user's body. The avatar 114 shows the user how to complete the task by providing a nudge 116. A nudge 116 is a slow movement of the avatar 114 so that the user can see how to move their body to complete the task 110. Once the user moves their body, the movement is transposed onto the avatar's 114 movement so that the user can see themselves following the avatar's lead. The system can be adjusted so that the user can see the display and avatar from various viewpoints, including from the viewpoint of the user.

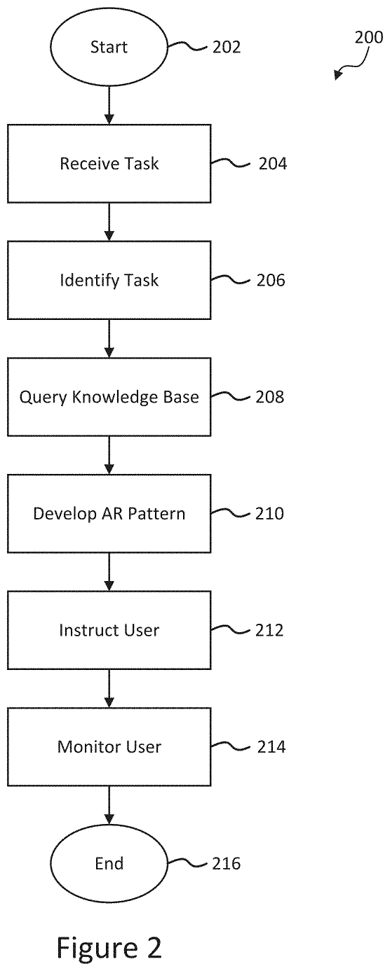

FIG. 2 is a flow diagram of a method for completing a task using an AR system 200. The method begins at 202. At 204, the AR system receives a task from a user device. At 206, the AR system identifies the task. The task received may be a query, such as “how do I hammer a nail” or an image of a nail started in board. The AR system uses a search to identify the task either by matching the words in the query or by identifying the task from the picture of the board with a nail not hammered in yet. Smart searches identify objects based on their images. Products may be identified by barcodes, QR codes, text, or other visual characteristics of the product or its packaging.

Once the system has identified the task, at 208, the AR system queries the knowledgebase. The knowledgebase contains existing AR patterns as well as many documents including written instructions, diagrams, and other sources. At 210, the AR system develops an AR pattern. If an AR pattern does not exist, the system develops an AR pattern for completing the task using the documents in the knowledgebase. The AR patient can include video, pictures, spoken instructions, background noise (such as hammering), etc.

If an AR pattern already exists, the AR system looks to develop an improved AR pattern using feedback from last use the AR pattern, user comments and other resources. Preferably, the AR pattern also uses actual pictures or video submitted by the user at 204. Each AR pattern is tailored to the current, specific task identified. For example, perhaps the nail is seated crooked in the picture submitted in 108 of FIG. 1. The AR pattern would be adapted to include how to straighten the nail prior to hammering.

The AR system can determine the AR pattern from exploded diagrams or blueprints. The AR system can use an existing video to develop the AR pattern. For example, from a video of the user assembling a product, an AR pattern can be created. The AR system can then create the reverse as well for dissembling the product. The AR pattern can show appropriate tools for the task or disable a machine before a task. The AR system can use laws of science and math to improve manufacturer's instructions. The AR pattern can include sounds and listen for the correct sounds, for example hammering of a nail by the user. The AR system can then verify that it is hearing the correct sound. Sound verification can be used as an accessibility feature for the hard of hearing.

At 212, using the AR pattern, the system instructs the user how to perform the task using an avatar of the user's body. In the example of FIG. 1, the avatar performs a “nudge” whereby the avatar slowly moves so that the user can see how their body should move. When the user moves their body, the movement is transposed onto the avatar's movement so that the user can see themselves following the avatar's lead. Preferably, the view to the user would be the same view as that of the user. The user would complete each of the steps as indicated by the avatar until the task is complete. During the tutorial, at 214, the AR system monitors the user for compliance with the instructions and other feedback. The AR system can use this information to repeat the tutorial, inform the user that she is doing something incorrect, redo the tutorial and store the feedback for later use in developing new AR patterns. The method ends at 216

Using FIG. 2, an example of folding a band saw blade using an AR pattern is explained. There are three components: the user, the AR system, including an app on the user's device, and the AR pattern. The app can render all kinds of images, video, text, sound, etc. and capture images, video, text and sound. The AR pattern is what is created and tailored to the current, specific task. The user wants to fold a bandsaw blade and uses the app to capture an image of the bandsaw. The AR system finds instruction on how to fold the blade from the manufacturer's web site and creates an AR pattern for folding the blade. The AR pattern starts with safely. “Put on gloves shoes and goggles.” The AR system has recognized that the manufacturer's instructions recommended gloves for touching the blade, so it also recommends shoes. If the user is already wearing gloves and shoes, the app can skip those instructions. The AR systems can also know about general safety recommendations, perform a risk assessment and suggest goggles.

The app then creates an avatar of the user's body and displays it along with the user's real image. Using the avatar, the app shows the user how the user should look after picking up the blade. The user moves her body to match this position; the app monitors the user's movements and tell her when she is in a position, which is close enough. The app can show the user from various viewpoints, such as looking down, looking in a mirror or a forward view of the user. The app slowly beings to nudge the avatar to perform the operation. As the user moves her arm, the movement is detected and transposed onto the avatar's movement. The app can follow the users lead to determine how fast the avatar should move. If the user makes a mistake, the app can instruct the user on the mistake to try to correct it. The app indicates when the task the completed and asks the user whether she wants to save the interaction. In an example of shooting a basketball, the user may use the AR pattern over and over again until the user develops a perfect shooting form.

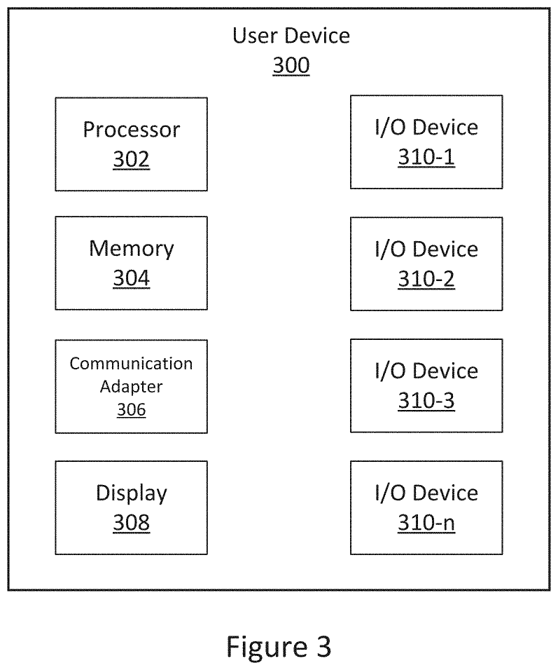

Referring to FIG. 3, an embodiment of a user device 300, such as user device 206 of FIG. 2, is shown. The user device includes a processor 302. The processor 302 may be a general-purpose central processing unit (“CPU”) or microprocessor, graphics processing unit (“GPU”), and/or microcontroller. The processor 302 may execute the various logical instructions according to the present embodiment.

The user device 300 also contains memory 304. The memory 304 may include random access memory (“RAM”), which may be synchronous RAM (“SRAM”), dynamic RAM (“DRAM”), or the like. The user device 300 may utilize memory 304 to store the various data structures used by a software application. The memory may also contain include read only memory (“ROM”) which may be PROM, EPROM, EEPROM, optical storage, or the like. The ROM may store configuration information for booting the user device 300. The memory 304 holds user and system data and may be randomly accessed.

The user device 300 includes a communications adapter 306. The communications adaptor 306 may be adapted to couple the user device 300 to a network, which may be one or more of a LAN, WAN, and/or the Internet. The communications adapter 306 may also be adapted to couple the user device 300 to other networks such as a GPS or Bluetooth network. The communications adapter 306 may allow the user device 300 to communicate with an edge hosted knowledgebase.

The user device 300 also includes a display 308. The display device 308 allows the user device to display images, video, and text to the user. The display device may be a smartphone or tablet computer screen, an optical projection system, a monitor, a handled device, eyeglasses, a head-up display (“HUD”), a bionic contact lens, a virtual retinal display, and another display system known in the art.

The user device 300 also includes at least one input/output (“I/O”) device 310. The I/O devices allow the user to interact with the user device. I/O devices include cameras, video cameras, microphones, touch screens, keyboards, computer mice, accelerometers, global positioning systems (“GPS”), compasses, gyroscopes and other similar devices known to those of skill in the art.

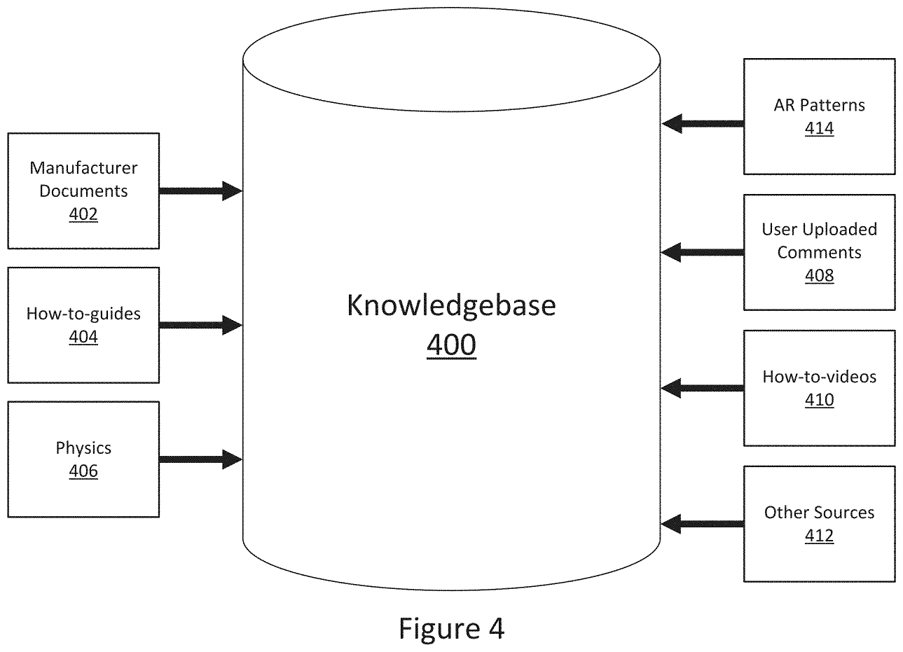

Referring to FIG. 4, in an embodiment of a knowledgebase 400 is illustrated. The knowledgebase 400 includes existing AR patterns 414 as well as documents and information pertaining to completing tasks. The knowledgebase collects information from various sources, including manufacturer documents 402, how-to-guides 404, general knowledge of physics 406, user uploaded comments 408, how-to-videos 410, and other sources 412. The knowledgebase 400 may also acquire information from manufacturers of products, user uploads, the Internet, or common sources of instruct such as YouTube.com.

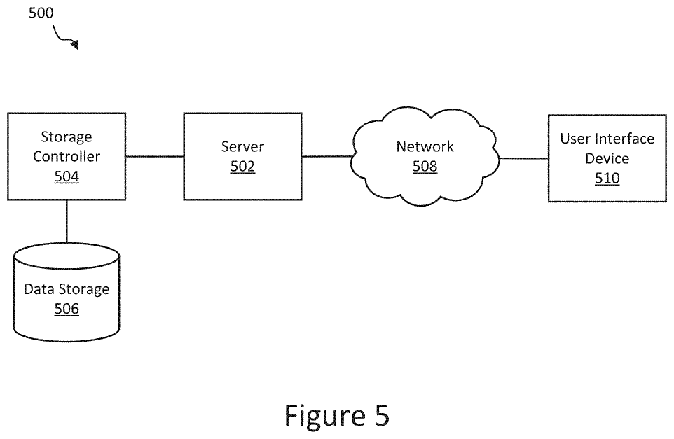

FIG. 5 illustrates one embodiment of a system 500 for an information system, which may host virtual machines. The system 500 may include a server 502, a data storage device 506, a network 508, and a user interface device 510. The server 502 may be a dedicated server or one server in a cloud computing system. The server 502 may also be a hypervisor-based system executing one or more guest partitions. The user interface device 510 may be, for example, a mobile device operated by a tenant administrator. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as user device 300, a desktop computer, a laptop computer, a personal digital assistant (PDA) or tablet computer, a smartphone, a gaming system such as a Sony PlayStation or Microsoft Xbox, or another mobile communication device having access to the network 508. The user interface device 510 may be used to access a web service executing on the server 502. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and provide a user interface for enabling a user to enter or receive information.

The network 508 may facilitate communications of data, such as dynamic license request messages, between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 510 accesses the server 502 through an intermediate server (not shown). For example, in a cloud application the user interface device 510 may access an application server. The application server may fulfill requests from the user interface device 510 by accessing a database management system (DBMS). In this embodiment, the user interface device 510 may be a computer or phone executing a Java application making requests to a JBOSS server executing on a Linux server, which fulfills the requests by accessing a relational database management system (RDMS) on a mainframe server.

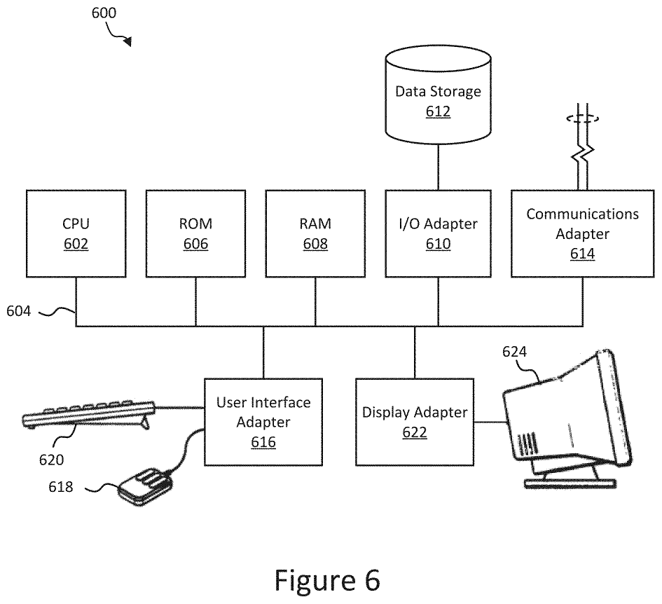

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 608, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical and/or logical.

1. A computer implemented method of training a user to perform a task, the method comprising:
receiving task data from a user device;
identifying a task associated with the task data;
querying a knowledgebase for data associated with the task;
generating an AR pattern for training the user to perform the task; and
transmitting the AR pattern to the user device.

2. An augmented reality training system comprising:
a computer device connected to a user device having a video camera and for receiving digital video data from the video camera, the computer device having software for identifying a task from the digital video data; and
a knowledgebase that is connected to the computer device, the knowledgebase containing resources related to the task;
wherein the system identifies a task to be performed, the system queries the knowledgebase for resources, the system creates an augmented reality pattern with an avatar from the resources for training a user and the system provides the augmented reality pattern to the user device.

3. A computer device for training a user to perform a task, the computer device comprising:
software for receiving digital video data from a user device;
software for identifying a task associated with the digital video data;
software for querying a knowledgebase for data associated with the task;
software for generating an AR pattern for training the user to perform the task; and
software for transmitting the AR pattern to the user device;
wherein a user can be trained to perform the task using the AR pattern.
